(19) United States
(12) Patent Application Publication
(10) Pub. No.: US 2022/0212435 A1
(43) Pub. Date: Jul. 7, 2022

(54) HOLLOW ARTICLE WITH OPTIMIZED INTERNAL STRUCTURAL MEMBERS

(71) Applicant: ABC TECHNOLOGIES INC., Toronto (CA)

(72) Inventors: Chao LI, Thornhill (CA); Sunny MOTWANI, Toronto (CA)

(21) Appl. No.: 17/702,984

(22) Filed: Mar. 24, 2022

Related U.S. Application Data
(63) Continuation of application No. 16/519,336, filed on Jul. 23, 2019.
(60) Provisional application No. 62/702,690, filed on Jul. 24, 2018.

(51) Int. Cl. B32B 3/20; E04B 5/02

(52) U.S. Cl. CPC B32B 3/20; B33Y 80/00; E04B 5/02

(57) ABSTRACT

A composite panel includes a first skin layer, an intermediate structural core, and a second skin layer. The first and second skin layers are disposed on opposing sides of the intermediate structural core. The intermediate structural core provides a geometric array of structural members, the arrangement of which is defined using topology optimization.

### CROSS-REFERENCE TO RELATED APPLICATIONS

This application claims the benefit of prior U.S. Provisional Patent Application Ser. No. 62/702,690, filed Jul. 24, 2018, which is hereby incorporated by reference in its entirety for all purposes.

### FIELD OF THE INVENTION

The present invention relates to hollow articles with internal structural members, and a process for manufacture.

### BACKGROUND

Composite panels have many uses in industry and serve, for example, as load bearing structural panels or load floors in aviation and automotive applications. A principal application for composite panels is in the automotive sector where it is desirable to replace bulky and heavy prior art panel systems with light-weight structural constructs having a maximum of strength for a minimum of weight and cost. Conventional construction methodologies have incorporated materials such as plastics at excess amounts, due to a lack of intelligent manufacturing processes, where material usage is calculated based on an optimization process. It is therefore an ongoing desire to improve upon manufacturing processes of a composite panel that achieves predetermined performance criteria, while increasing material usage efficiency and reducing overall component weight.

### SUMMARY OF THE INVENTION

According to an aspect of an embodiment, a composite panel includes a first skin layer, an intermediate structural core, and a second skin layer. The first and second skin layers are disposed on opposing sides of the intermediate structural core. The intermediate structural core provides a geometric array of structural members, the arrangement of which is defined using topology optimization.

### BRIEF DESCRIPTION OF THE DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a partial sectional perspective view of a load floor exemplifying an embodiment of the invention.

FIG. 2 is a sectional view of the load floor according to FIG. 1.

FIG. 3 is a sectional view of an alternative embodiment of a load floor, including a covering.

FIG. 4 is a sectional view of an alternative embodiment of a load floor, including a covering and a reinforcement layer.

FIG. 5 is a sectional view of an alternative embodiment of a load floor, including a reinforcement layer without a covering.

FIG. 6 shows an exemplary geometric array of structural members for a structural core of a load floor.

FIGS. 7a to 7f provide alternative geometric arrays based on topology optimization.

FIG. 8 shows a structural core having an open-cell configuration.

### DETAILED DESCRIPTION OF EMBODIMENTS OF THE PRESENT INVENTION

Specific embodiments of the present invention will now be described with reference to the Figures, wherein like reference numbers indicate identical or functionally similar elements. The following detailed description is merely exemplary in nature and is not intended to limit the invention or the application and uses of the invention. A person skilled in the relevant art will recognize that other configurations and arrangements can be used without departing from the scope of the invention. Although the description and drawings of the embodiments hereof exemplify the formation/use of structural members in load floors, the invention may also be used in other manufacturing arrangements where it is deemed useful. Furthermore, there is no intention to be bound by any expressed or implied theory presented in the preceding technical field, background, brief summary or the following detailed description.

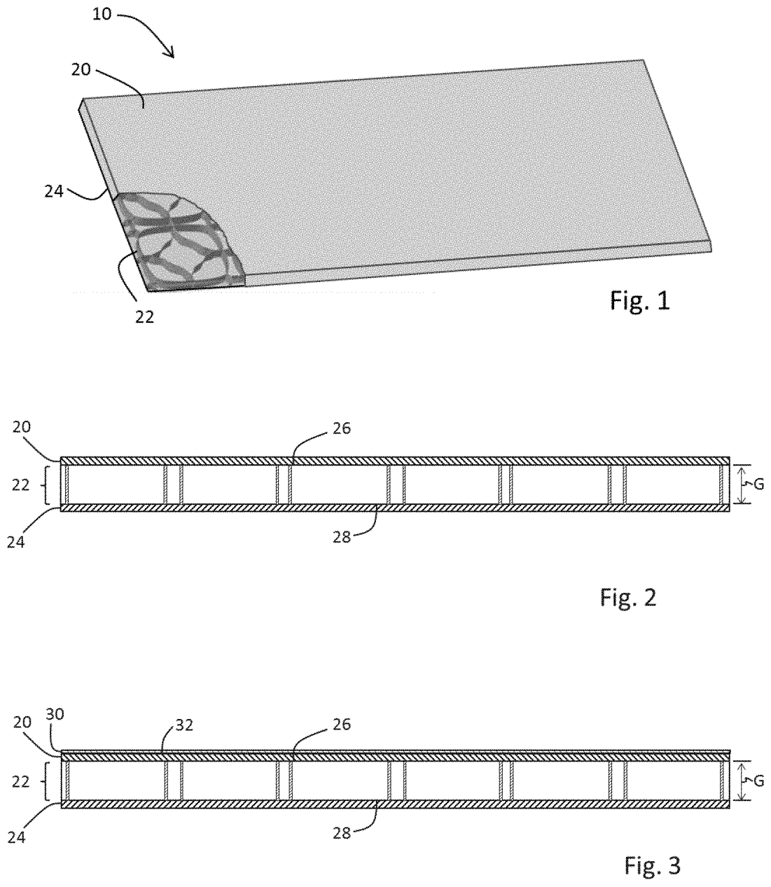

Turning now to FIG. 1, shown in partial-sectional perspective view is a structural panel according to an embodiment of the invention. More specifically, shown is an exemplary article known as a load bearing structural floor commonly used in motor vehicles, which is herein referred to as a load floor 10. The load floor 10 is generally formed as a composite panel, including at least two layers that cooperate to provide the desired form and performance or function.

As shown more clearly in FIG. 2, the load floor 10 includes three layers, namely a first skin layer 20, an intermediate structural core 22, and a second skin layer 24. The first skin layer 20 and the second skin layer 24 are positioned or disposed on opposing sides of the intermediate structural core 22. More specifically, the first skin layer 20 is positioned on a first side 26 of the structural core 22, while the second skin layer 24 is positioned on a second side 28 of the structural core 22. As the first and second sides 26, 28 are opposing sides of the structural core 22, the first and second skin layers 20, 24 associated therewith are spaced apart or separated by gap G.

The first and second skin layers 20, 24 may be separately formed and attached to the structural core 22, for example through a suitable weldment process such as but not limited to IR welding, and vibration welding, or through the use of a suitable adhesive such as but not limited to a high-bond adhesive tape or adhesive glue. The first and second skin layers 20, 24 may also be mechanically captured using retention features to lock in the ribs or core (i.e., with dove tail features, snap fit features or locating features in different directions C/C and F/A). It will also be appreciated that one or both of the first and second skin layers 22, 24 may be integrally formed with the structural core, as will be described in greater detail below.

In some applications, it is desirable to have a covering material applied to or disposed on one or both sides of the load floor 10. For example, it may be desirable to apply a carpet material to one side of the load floor 10 so as to meet desired performance and/or aesthetics characteristics. As such, provided in FIG. 3 is an alternative embodiment of the load floor 10 where a covering 30 is provided on an outside surface 32 of the first skin layer 20.

The covering 30 may be applied to the first skin layer 20 using a suitable adhesive, although it will be appreciated that other attachment methodologies are possible, such as being integrally bonded where the first skin layer 20 is molded. The covering 30 may be a wide range of materials, including but not limited to carpet (woven or non-woven) and sheets of varying forms such as solid and perforated configuration. Suitable materials for coverings include, but are not limited to polypropylene, polyester, polyamide, vinyl and TPO.

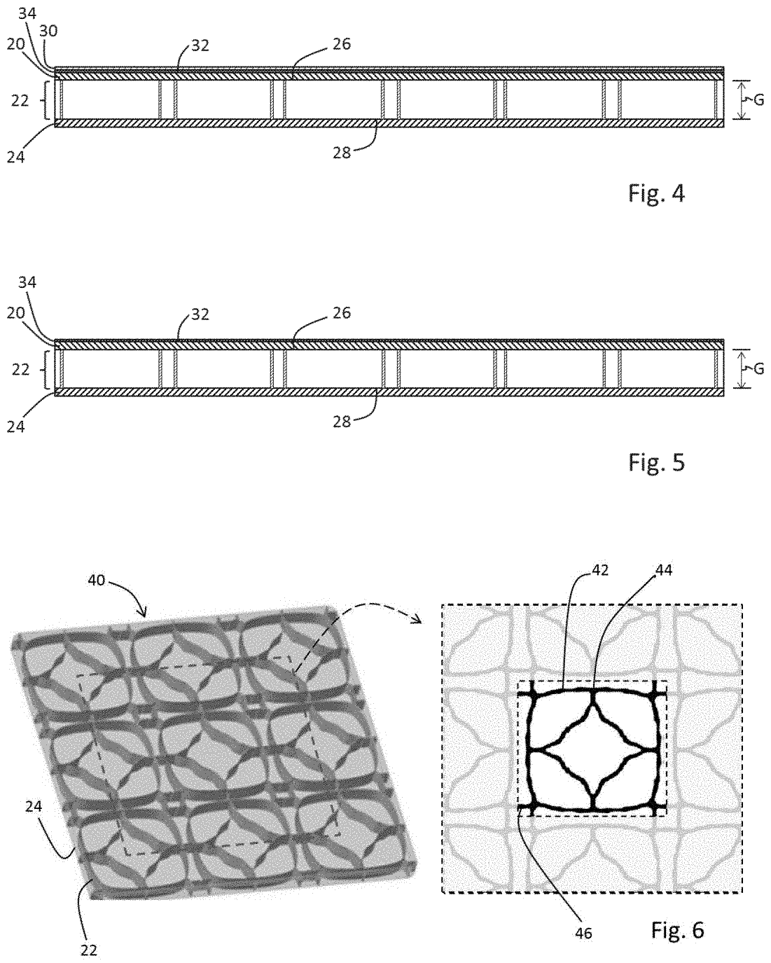

In some embodiments, one or more reinforcement layers may be incorporated into the load floor 10. For example, in the load floor 10 shown in FIG. 4, a single reinforcement layer 34 is provided as an intermediate layer between the outside surface 32 of the first skin layer 20 and the covering 30.

In other embodiments, such as the load floor 10 shown in FIG. 5, the reinforcement layer 34 may be provided on the outside surface 32 of the first skin layer 20 without a further covering material added.

Similar to the covering 30, the reinforcement layer 34 may be applied to the first skin layer 20 using a suitable adhesive, although it will be appreciated that other attachment methodologies are possible, such as being integrally bonded.

Exemplary reinforcement layers include, but are not limited to mesh, fabric and plastic. Exemplary mesh materials include metal, glass, plastic and carbon fibre. Exemplary fabrics may be woven or non-woven, and may include synthetic and/or non-synthetic materials, such as, but not limited to hemp, jute and leather. Exemplary plastics may include polyamide (e.g. aramid), and any filled synthetic resin containing organic or inorganic fillers, such as, but not limited to talc, mica, carbon fiber and glass. The reinforcement layer 34 may be continuous over the entire surface, or may be discontinuous, that is only partially cover the article. In some embodiments, the reinforcement layer 34 may alternatively or additionally be provided on an outside surface of the second outside layer 24.

The structural core 22 provides the primary strength and rigidity of the structural panel and is generally regarded as a planar construct when the structural panel has the form of a load floor 10. The structural core 22 provides an array of structural members 40, generally arranged as a plurality of geometric cells arranged in repeating pattern over the planar area defining the load floor 10. An exemplary array of structural members is shown in FIG. 6.

Each geometric cell includes at least one structural rib 42, at least one structural node 44, and at least one structural web 46. The structural ribs 42 define the principle structure of the geometric cell, the structural nodes 44 are generally defined as the location where two or more structural ribs 42 intersect, and the structural webs 46 serve to interconnect adjacent geometric cells. The geometric cells, in particular the walls defining the cells, are aligned to extend transversely relative to the load floor 10 or stated another way, are aligned to extend across the thickness of the structural core 22. Accordingly, in an assembled load floor 10 having first and second skin layers 20, 24, the geometric array of structural members 40 of the structural core 22 span the gap G and fixedly engage to the respective first and second skin layers 20, 24.

It will be appreciated that the load floor 10, may be constructed in a variety of ways, to achieve the desired performance characteristics. In particular, the selection of the structural core 22 is central to achieving the desired functional form. Parameters to be considered in the design will include, but are not limited to the expected stress loads, the manner by which the load floor 10 will be supported (i.e. the location of the boundary supports) when in use, the localized stress loads in the vicinity of the boundary supports, the material properties, the dimension of the cell size, the optimization objective and the performance constraints.

An effective and efficient method of accounting for these parameters in the design of the structural core 22, in particular the geometric array of structural members 40, is topology optimization. Topology optimization is developed to find the quantity, location, shape of the key design features, and the connectivity of design domains. Topology optimization has the capability to achieve the optimal configuration of the structural core 22 based on rigorous mathematical algorithm under the predetermined stress load and loading attributes of the load floor 10. Accordingly, for a given set of parameters inputted into the topology optimization algorithm, an optimal geometric array of the structural members is generated, depending on the constraints enforced on the algorithm. With an optimal geometric array of structural members determined, an appropriate manufacturing methodology may be selected to form the targeted the load floor 10.

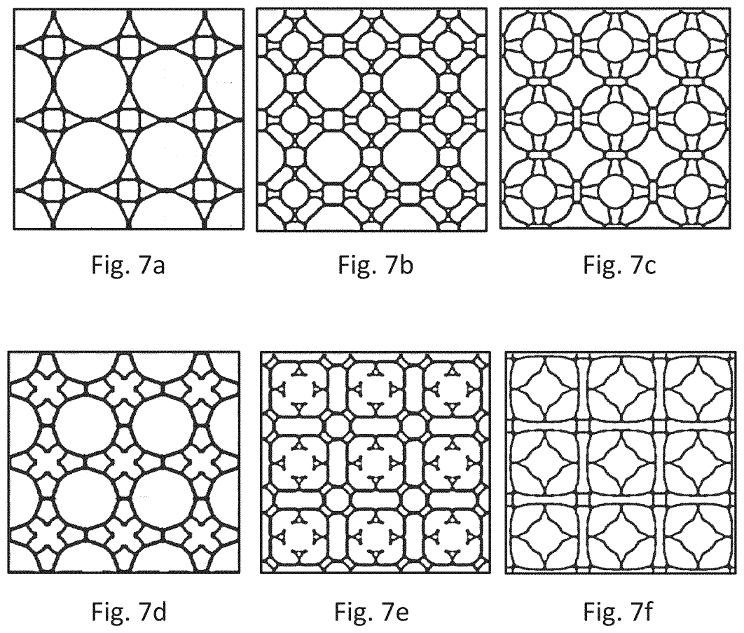

With reference now to FIGS. 7a to 7f, shown are exemplary geometric arrays for the structural members 40 of the structural core 22. For a given stress or load profile, topology optimization identified an optimal geometric cell configuration. Select stress or load profiles are provided in Table 1, which correspond to the geometric arrays provided in the figures.

Based on the optimal topology, detailed structural optimization methods such shape optimization and size optimization may be implemented to further tune the local shape and the thickness of the structural members 40. The resultant geometric arrays may be subject to further geometry interpretation to ensure the design conforms to the available and/or selected manufacturing processes. For example, where the structural core 22 is to be formed using an injection molding process, the thickness of the structural ribs 42, the structural nodes 44 and the structural webs 46 are selected to be at least 0.65 mm. It will be appreciated, however, that other thicknesses for one or more of the structural ribs 42, the structural nodes 44 and the structural webs 46 may be above or below this selected value. It will also be appreciated that shapes can be continuous or discontinuous based on manufacturing requirements. Rib thicknesses, cell shape and spacing can vary locally based on load or support requirements.

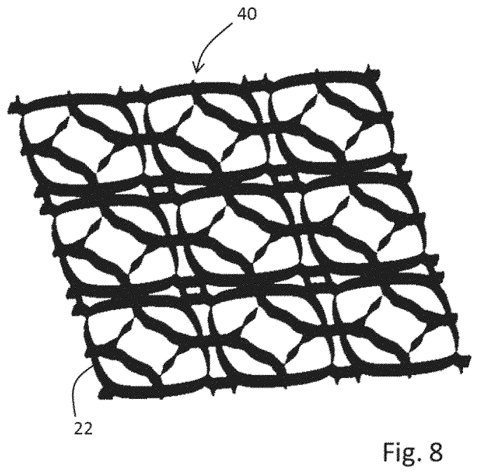

The structural core 22 may be formed using an injection molding process. In one embodiment, the structural core 22 may be formed without a skin layer provided on either side. Accordingly, the structural core 22 would have an open-cell structure, composed solely of the structural members 40 with in an optimized geometric configuration based on topology optimization. An exemplary structural core 22 formed in accordance with this methodology is depicted in FIG. 8. In this form, the structural core 22 generally serves as a structural insert for other molding or manufacturing processes.

For example, the structural core 22 may be incorporated into a compression molding or vacuum forming process where the structural core 22 would receive one or both of the first and second skin layers 20, 24 using a suitable adhesive or bonding process. Alternatively, the structural core 22 may be incorporated into a blow molding operation where the structural core 22 is disposed as a structural insert within the parison.

In an alternative embodiment, the structural core 22 may be an integral geometric projection formed on at least one of the first and second skin layers. This may be achieved through an injection molding process, where the process of forming the skin layer includes the injection molding of the structural members 40 of the structural core 22 directly upon an inside surface of one of the first and second skin layers 20, 24. In a subsequent manufacturing step (i.e., compression molding or vacuum forming), the opposing skin layer would be bonded to the opposing open-side of the structural members 40, therein encasing the structural core 22 therebetween.

In another alternative embodiment, the structural core 22 may be integrally formed upon each of the first and second skin layers. In this arrangement, it will be appreciated that the assembled form of the structural panel has a targeted structural core thickness. Accordingly, the first skin layer 20 will be formed with a first portion of the structural members 40, while the second skin layer 24 is formed with a second portion of the structural members 40. The structural members 40 provided on each of the first and second skin layers 20, 24 are arranged to align on assembly, and the first and second portions are suitably dimensioned to form on assembly a structural core with the targeted structural core thickness. In one embodiment, the portions of the structural members 40 provided on each of the first and second skin layers includes 50% of the targeted structural core thickness. In another embodiment, one of the first and second skin layers is configured to receive >50% of the portion of the structural members, with the opposing skin layer receiving a complementary portion to achieve the targeted structural core thickness. For clarity, the term portion is used relative to the targeted structural core thickness. For example, where the targeted structural core thickness is 1 cm, and wherein each of the first and second skin layers are configured to receive a 50% portion, the structural members 40 provided on each of the first and second skin layers will be 0.5 cm.

In addition to injection molding, the structural core 22 may be formed using a variety of 3-D printing (additive manufacturing) methodologies including, but not limited to free form fabrication (FFF), direct manufacturing (DM), fused deposition modelling (FDM), powder bed printing (PBP), laminated object manufacturing (LOM), stereolithography (SL), selective laser sintering (SLS), selective laser melting (SLM), selective heat sintering (SHS), electron beam melting (EBM), direct ink writing (DIW), digital light processing (DLP) and additive layer manufacturing. These systems are used for generating three-dimensional objects by creating a cross-sectional pattern of the object to be formed and forming the three-dimensional solid object by sequentially building up layers of material. These techniques generally include selectively depositing material layer by layer, selectively fusing or solidifying the material and removing excess material, if needed. With this approach, the structural core 22 can be made and used in a subsequent manufacturing process, such as the compression molding, vacuum forming, and blow molding processes mentioned above.

The load floor 10 is made from a thermoplastic material that has sufficient strength and rigidity to meet the desired performance characteristics. A non-limiting example of suitable materials includes polypropylene, polyethylene, ABS, ABS/PC, polyamide, PLA and PPS. To meet desired strength and rigidity requirements, the thermoplastic may additionally include a range of inorganic filler components, a non-limiting example of which includes glass, mica, calcium carbonate and talc, and/or organic filler components, a non-limited example of which includes jute, husk, and hemp. The structural core 22 and the first and second skin layers 20, 24 may be formed of the same material, or of different materials, depending on the intended application.

While various embodiments according to the present invention have been described above, it should be understood that they have been presented by way of illustration and example only, and not limitation. It will be apparent to persons skilled in the relevant art that various changes in form and detail can be made therein without departing from the scope of the invention. Thus, the breadth and scope of the present invention should not be limited by any of the above-described exemplary embodiments but should be defined only in accordance with the appended claims and their equivalents. It will also be understood that each feature of each embodiment discussed herein, and of each reference cited herein, can be used in combination with the features of any other combination. All patents and publications discussed herein are incorporated by reference herein in their entirety.

1-11. (canceled)

12. A method of making a hollow article, the method comprising:
forming a structural core having a plurality of geometric cells arranged in a geometric array determined through a topology optimization process based on desired performance characteristics;
providing a first skin layer for arrangement on a first side of the structural core;
providing a second skin layer for arrangement on a second side of the structural core, the second side opposing the first side;
arranging the first skin layer, the second skin layer and the structural core in a molding environment; and
forming the hollow article in the molding environment such that hollow article includes the first skin layer and the second skin layer disposed on opposing sides of the structural core.

13. The method of claim 12, wherein the structural core is an integral geometric projection formed on at least one of the first and second skin layers prior to the step of arranging the first skin layer, the second skin layer and the structural core in the molding environment.

14. The method of claim 13, wherein the geometric projection is formed on at least one of the first and second skin layers through an injection molding process.

15. The method of claim 12, wherein the structural core is an integral geometric projection formed on each of the first and second skin layers, with each of the first and second skin layers including a portion of the structural core, and wherein the step of forming the hollow article includes bonding the portions of the structural core on each of the first and second skin layers together to form the structural core having a thickness.

16. The method of claim 15, wherein each portion of the structural core provided on the first and second skin layers is 50% of the thickness of the structural core.

17. The method of claim 15, wherein the portion of the structural core provided on one of the first and second skin layers is greater than 50% of the thickness of the structural core, while the portion of the structural core provided on the other of the first and second skin layers is a complementary portion to achieve the thickness.

18. The method of claim 12, wherein the molding environment is a compression molding process.

19. The method of claim 12, wherein the molding environment is a vacuum forming process.

20. The method of claim 12, wherein the molding environment is a blow molding process.

21. The method of claim 12, wherein the step of forming the structural core includes forming the structural core via injection molding.

22. The method of claim 12, wherein the step of forming the structural core includes forming the structural core via an additive manufacturing methodology.

23. A method of making a composite panel, the method comprising:
providing a first skin layer for arrangement on a first side of a structural core;
providing a second skin layer for arrangement on a second side of a structural core, the second side opposing the first side;
forming a structural core on at least one of the first and second skin layers, the structural core having a plurality of geometric cells arranged in a geometric array determined through a topology optimization process based on desired performance characteristics;
arranging the first skin layer, the second skin layer and the structural core in a molding environment; and
forming the composite panel in the molding environment such that the composite panel includes the first skin layer and the second skin layer disposed on opposing sides of the structural core.

24. The method of claim 23, wherein the step of forming the structural core on at least one of the first and second skin layers includes forming the structural core via injection molding.

25. The method of claim 23, wherein the step of forming the structural core on at least one of the first and second skin layers includes forming a first portion of the structural core on the first skin layer and forming a second portion of the structural core on the second layer and wherein the step of forming the composite panel in the molding environment includes bonding the first and second portions of the structural core together.

26. The method of claim 25, wherein the structural core has a thickness and wherein each of the first and second portions of the structural core includes 50% of the thickness.

27. The method of claim 25, wherein the structural core has a thickness and wherein the first portion of the structural core includes 50% or more of the thickness and the second portion of the structural core includes a complimentary portion of the thickness.
